(19) United States
(12) Patent Application Publication
(10) Pub. No.: US 2011/0310070 A1
(43) Pub. Date: Dec. 22, 2011

(54) IMAGE SPLITTING IN A MULTI-MONITOR SYSTEM

(76) Inventors: Henry ZENG, Sunnyvale, CA (US); Jing QIAN, Shanghai (CN); Xiaoqian ZHANG, Shanghai (CN); Xuexin LIU, Shanghai (CN)

(21) Appl. No.: 13/160,443

(22) Filed: Jun. 14, 2011

Related U.S. Application Data
(60) Provisional application No. 61/355,971, filed on Jun. 17, 2010.

(51) Int. Cl. G09G 5/00

(52) U.S. Cl. 345/204

(57) ABSTRACT

A multi-monitor display driver that splits a received video image into multiple images for display on separate monitors. The driver includes a line buffer where data from a received image is written. Monitor interfaces can receive data from a portion of the line buffer corresponding to the interface to split the image.

### RELATED APPLICATION

This application claims priority to U.S. Provisional Application No. 61/355,971, filed on Jun. 17, 2010, which is hereby incorporated by reference in its entirety.

### BACKGROUND

1. Technical Field

The present invention is related to a multi-monitor control system and, in particular, image splitting in a multi-monitor control system.

2. Discussion of Related Art

It is becoming more common to utilize multiple monitors. According to a survey by Jon Peddie Research cited in The New York Times, Apr. 20, 2006, it is estimated that use of multiple monitors can increase worker efficiency between 20 to 30 percent. Utilization of multiple monitors can also greatly enhance entertainment such as video gaming or movies.

However, obtaining multiple monitors typically requires multiple video graphics drivers, one for each monitor. Desktop computers, for example, may have multiple graphics cards or a graphics card with multiple drivers on the card. Notebook computers may include a PCMIA cardbus card or such to drive multiple monitors. Further, USB ports may be utilized to drive additional monitors.

However, these options are expensive to implement, require hardware upgrades for addition of each extra monitor, and usually consume large amounts of power. USB ports may also not have enough bandwidth, especially if other devices are also utilizing the port, to provide good resolution to the monitors.

Therefore, there is a need for systems that allow use of multiple monitors.

### SUMMARY

In accordance with some embodiments of the present invention, a multi-monitor driver, can include a processor coupled to receive an image; a line buffer coupled to the processor, the processor writing pixel data from the image into the line buffer; and a plurality of monitor interfaces, each coupled to receive data from a corresponding portion of the line buffer to form a smaller image that is a portion of the image.

A method of splitting an image according to some embodiments of the present invention includes receiving the image; writing data from the image into a line buffer; and reading video data from a portion of the line buffer to form a smaller image that corresponds to a portion of the image.

These and other embodiments will be described in further detail below with respect to the following figures.

### BRIEF DESCRIPTION OF THE DRAWINGS

FIG. 1 illustrates a multi-monitor driver according to some embodiments of the present invention.

FIG. 2A illustrates transmission of an image according to the DisplayPort standard.

FIG. 2B illustrate packing of pixel data in RGB format according to the DisplayPort standard.

FIG. 3 illustrates splitting a video image into multiple horizontally distributed video images.

FIG. 4 illustrates splitting a video image into multiple vertically distributed video images.

FIG. 5 illustrates splitting a video image into both horizontally and vertically distributed video images.

FIG. 6 illustrates the interactions between monitor interfaces and a video buffer according to some embodiments of the present invention.

FIG. 7 illustrates the video timing for a video image.

FIG. 8 illustrates the video timing for a monitor displaying a video image horizontally split from a larger video image.

FIG. 9 illustrates the video timing for a monitor displaying a video image vertically split from a larger video image.

FIG. 10 illustrates the video timing for a monitor displaying a video image that is both horizontally and vertically split from a larger video image.

In the drawings, elements having the same designation have the same or similar functions. Drawings are not necessarily to scale.

### DETAILED DESCRIPTION

In the following description specific details are set forth describing certain embodiments of the invention. It will be apparent, however, to one skilled in the art that the present invention may be practiced without some or all of these specific details. The specific embodiments presented are meant to be illustrative of the present invention, but not limiting. One skilled in the art may realize other material that, although not specifically described herein, is within the scope and spirit of this disclosure.

According to some embodiments of the present invention, a multiple monitor display system, which may include a video driver and multiple display devices (monitors), accepts a large image from an outside video source and splits the received large image into several small images. The small images are then displayed on multiple display devices (monitors). The video display controller, or video driver, connects with multiple display devices by several display device connectors. Each display device connector is designed to independently control a single display device. In accordance with embodiments of the invention, the display device connectors can be, for example, a Digital Visual Interface-Integrated (DVI-I) connector, a DVI-Digital (DVI-D) connector, a DVI-Analog (DVI-A) connector, a 15-pin Video Graphics Adapter (VGA) connector, a High-Definition Multimedia Interface (HDMI) connector, a DisplayPort™ connector, or a connector compatible with any other video standard.

The video source provides a video image in a format that is defined by an Extended Display Identification Data (EDID). EDID data resides in each display device and can be read out. In a multiple monitor display system, a video format compatible with the larger image can be stored in the video driver and read by a video source. The video driver then provides the split-out smaller image according to EDID data read from each of the individual monitors.

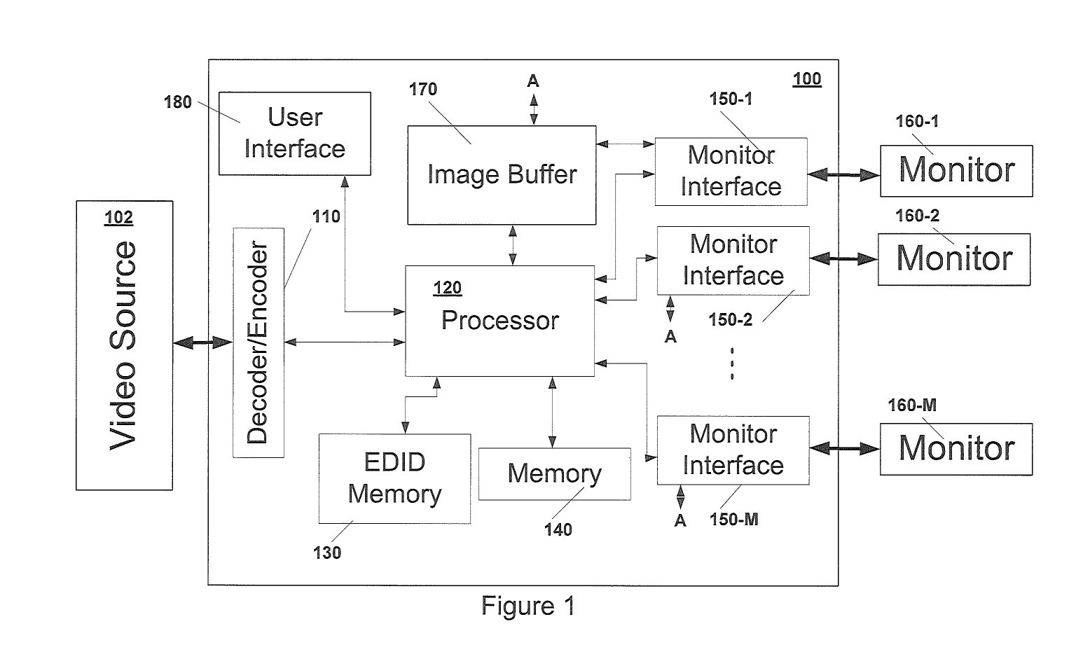

FIG. 1 illustrates a multi-monitor driver 100 according to some embodiments of the present invention. Multi-monitor driver 100 communicates with an outside source 102 through interface 110, which provides signals to processor 120. Embodiments of interface 110 can communicate with any outside source 102. In some embodiments, the outside source 102 and driver 100 are compatible with the DisplayPort standard (the “DP standard”). The VESA DisplayPort Standard, Version 1, Revision 1a, released Jan. 11, 2008, which is available from the Video Electronics Standard Association (VESA), 860 Hillview Court, Suite 150, Milpitas, Calif. 95035, is herein incorporated by reference in its entirety. In accordance with the DisplayPort standard, data is transmitted between the source 102 and interface 110 through three data links: a main link, an auxiliary channel, and a hot plug detect. Main link may include 1, 2, or 4 data lanes.

The DP standard currently provides for up to 10.8 Gbps (giga bits per second) through main link, which may support greater than QXGA (2048×1536) pixel formats, and greater than 24 bit color depths. Further, the DP standard currently provides for variable color depth transmissions of 6, 8, 10, 12, or 16 bits per component. In accordance with the DP standard, bi-directional auxiliary channel provides for up to 1 Mbps (mega bit per second) with a maximum latency of 500 micro-seconds. Furthermore, a hot-plug detection channel is provided. The DP standard provides for a minimum transmission of 1080p lines at 24 bpp at 50/60 Hz over 4 lanes at 15 meters.

Additionally, the DP standard supports reading of the extended display identification data (EDID) whenever the hot plug detecting channel indicates to the outside sink is connected. Further, the DP standard supports display data channel/command interface (DDC/CI) and monitor command and controls set (MMCS) command transmission. Further, the DP standard supports configurations that do not include scaling, a discrete display controller, or on screen display (OSD) functions.

The DP standard supports various audio and visual content standards. For example, the DP standard supports the feature sets defined in CEA-861-C for transmission of high quality uncompressed audio-video content, and CEA-931-B for the transport of remote control commands between a sink, such as multi-monitor driver 200, and an outside source. Although support of audio aspects is not important to embodiments of the present invention, the DP standard supports up to eight channels of linear pulse code modulation (LPCM) audio at 192 kHz with a 24 bit sample size. The DP standard also supports variable video formats based on flexible aspect, pixel format, and refresh rate combinations based on the VESA DMT and CVT timing standards and those timing modes listed in the CEA-861-C standard. Further, the DP standard supports industry standard colorimetry specifications for consumer electronics devices, including RGB and YCbCr 4:2:2 and YCbCr 4:4:4.

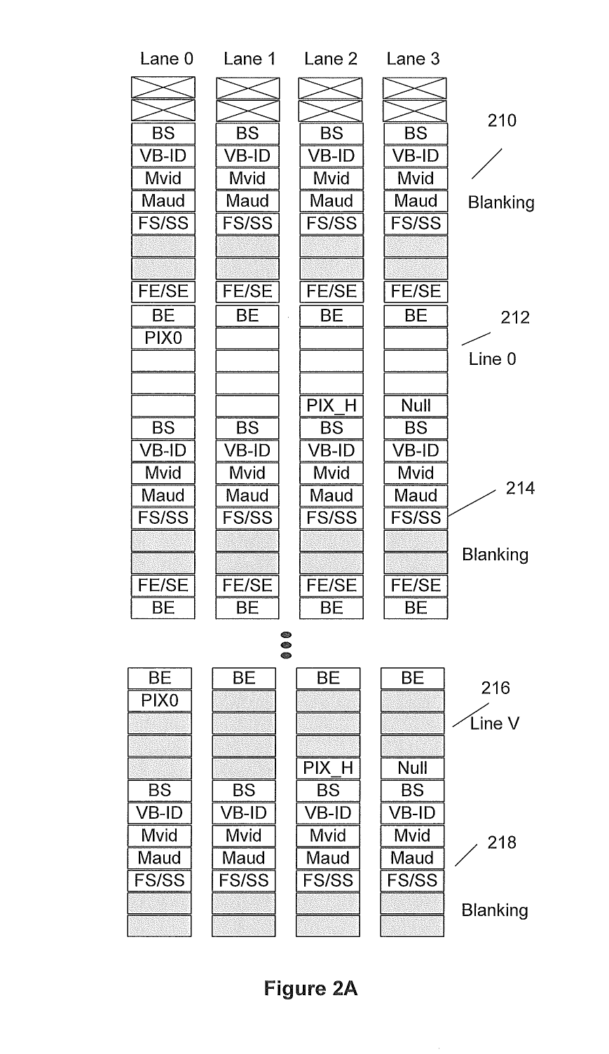

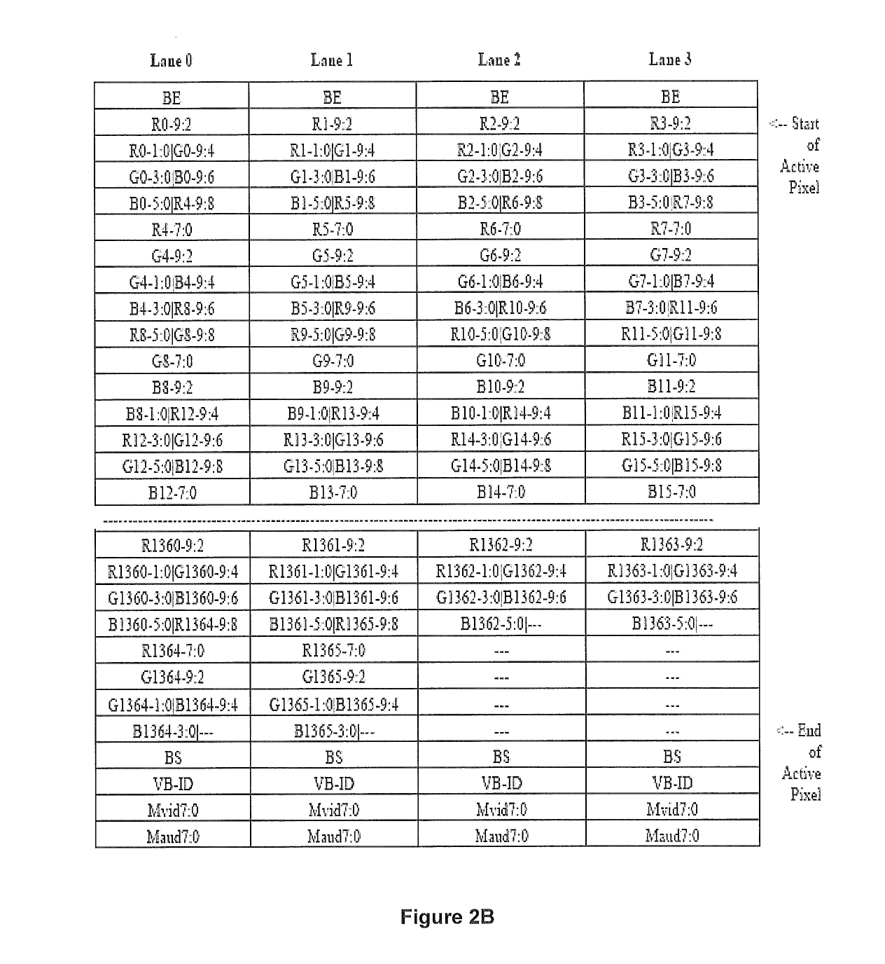

Processor 120 provides data for presentation on one or more monitors through monitor 160-1 through 160-M interfaces 150-1 through 150-M, where M can be any integer greater than or equal to one. Monitor interfaces 150-1 through 150-M each act as individual sources to the monitors coupled to them, monitors 100-1 through 100-M, respectively. As indicated in FIG. 2, each of monitor interfaces 150-1 through 150-M is coupled to a corresponding one of monitors 160-1 trough 160-M. Processor 120 can read the EDID data from each of monitors 160-1 through 160-M through monitor interface 150-1-monitor interface 150-M in order to construct EDID data to store in EDID memory 230. Constructing the EDID data is further explained in application Ser. No. 12/816,202, which is filed concurrently with the present application.

Processor 120 is further coupled to a memory 140. Memory 140 can include both RAM and ROM memories. Programming instructions and operating parameters, for example, may be stored in ROM memory. EDID memory 130, which may be combined with the RAM portion of memory 140, holds the EDID data that is provided to an outside video source 102 by processor 120 through decoder/encoder 110. In some embodiments, the EDID data produced by processor 120 is consolidated data considering the EDID data from each of monitors 100-1 through 100-M and follows the VESA EDID convention as discussed above. However, other conventions can be utilized.

Processor 120 is further coupled to a video buffer 170, which is utilized to split a video image that is received from source 102 into video images that are displayed on monitors 160-1 through 160-M. As shown in FIG. 1, in some embodiments monitor interfaces 150-1 through 150-M may read video data from video buffer 170. In some embodiments, video buffer 170 may be a part of memory 140.

Some examples of splitting DisplayPort compatible video data for distribution across multiple monitors is described, for example, in U.S. patent application Ser. No. 12/353,132, filed on Dec. 9, 2009; U.S. patent application Ser. No. 12/755,253, filed on May 6, 2010; U.S. patent application Ser. No. 12/634,571, filed on Jan. 13, 2009; each of which is incorporated herein by reference in its entirety. As discussed above, driver 100 may communicate with source 102 utilizing any standard and may communicate with monitors 160-1 through 160-M using any standard. One such standard is the DisplayPort standard discussed above.

FIG. 2A illustrates transmission of a video image of size H×V (H pixels by V lines) according to the DisplayPort standard. Although a four-lane example is shown in FIG. 2A, other lane configurations are similarly arranged. A data slot in each of the four lanes is transmitted each clock cycle. As shown in FIG. 2A, image data is sent after a horizontal blanking period 210. The horizontal blanking period 210 begins with a blanking Start (BS) symbol transmitted in each of the four lanes. Symbols transmitted before the BS symbol can be fill or can be previous image or audio data, but are not relevant for this discussion.

Following the BS symbol transmissions, a video blanking ID (VB-ID), a video time stamp (MVID), and an audio time stamp (MAUD) are sent. VB-ID includes a flag that is set to indicate whether or not a vertical blanking period exists. In this case, VB-ID should be set to indicate active video data. Prior to the start of transmission of the video image, VB-ID is likely to have been set to a blanking step indicating a vertical blanking period. MVID indicates a video time stamp, which is utilized for stream clock recovery. MAUD indicates an audio time stamp if the blanking period is utilized to transmit audio data. As shown in FIG. 2A, a fill start (FS) or secondary data start (SS) symbol is sent. If there is audio data (indicated by a non-zero MAUD), then the audio data can be transmitted. IF not, then fill data is transmitted until the blanking period is over, at which time a fill end (FE) or secondary data end (SE) symbol is sent in each of the lanes and a blanking end (BE) symbol is sent in the lanes immediately following the FE or SE symbols.

Following transmission of the BE symbol in each of the lanes, video data 212 is transmitted. Video data is in the form of pixels, which are packed into the four lanes. Pixels may be sequentially distributed across lanes starting with pixel 0 (PIX0) and ending with pixel H (PIX_H), as shown in FIG. 2A. The pixels are similarly packed across each of the lanes until the last pixel of the line is inserted. As shown in FIG. 2A, the last pixel in the line is often such that not all slots in all the lanes are filled. In the example shown in FIG. 2A, lane 3 is not filled. Unused slots can be padded, for example with nulls. Immediately following transmission of a line, another blanking period, period 214 begins. Blanking period 214 represents a horizontal blanking period. Again, audio data may be sent or the slots in each of the lanes filled.

Each line, line 0 through line V in an H×V transmission, is then transmitted. During each of the blanking periods between transmission of Line 0 data 212 and Line V data 216, VB-ID is set to indicate active video data. When Line V video data 218 has been transmitted, a BS symbol is again transmitted across each of the lanes followed The following VB-ID symbol is now set to indicate a vertical blanking period and MVID is set to 0, indicating no video data present. Audio data may still be transmitted, if present. Transmission begins again at blanking period 210 for transmission of the next image.

FIG. 2B illustrates an example encoding of 30 bpp RGB (10 bpc) 1366×768 video data into a four lane, 8-bit, link. As also illustrated in FIG. 2A, one data slot in each lane is transmitted per clock cycle. In the figure, R0-9:2 means the red bits 9:2 of pixel 0. G indicates green, and B indicates blue. BS indicates a blanking start and BE indicates a blanking end. Mvid 7:0 and Maud 7:0 are portions of the time stamps for video and audio stream clocks. As is indicated in FIG. 2, the encoding into four lanes occurs sequentially by pixel, with pixel 0 of the line being placed in lane 0, pixel 1 in line 1, pixel 2 in line 2, and pixel 3 in lane 3. Pixels 4, 5, 6, and 7 are then placed in lanes 0, 1, 2, and 3. The same packing scheme is utilized regardless of the number of lanes used by source 100. Source 100 and sink 120 may support any of 1, 2, or 4 lanes under the DP standard. Those that support 2 lanes also support single lanes and those that support 4 lanes support both 2 lane and 1 lane implementations.

Although FIG. 2B demonstrates a packing in four lanes of RGB video data, video data in other formats (e.g., YCrCb) can be similarly packed into 1, 2, or 4 lanes under the DisplayPort standard. FIGS. 2A and 2B illustrate an example of a four lane transmission of data. However, data may be transmitted over one lane or two lanes as well. The order of the transmission is the same as illustrated in FIG. 2A and the pixel packing scheme illustrated in FIG. 2B can be utilized with one or two lanes as well as with four lanes.

Monitors 160-1 through 160-M, attached to monitor interfaces 150-1 through 150-M, may be arranged in any way. For example, all of monitors 160-1 through 160-M may be physically positioned in a row of monitors, in a column of monitors, in a two-dimensional array of monitors, or in some other physical arrangement. In some embodiments, processor 120 may receive a user-input parameter through a user interface 180. User interface 180 may take any form, for example a touchscreen, a video screen or lighted indicators with associated mechanical switches, or even one or more toggle switches with no indicators to input a pre-determined code that determines user settable operating parameters for driver 100. For example, user settable operating parameters may indicate the physical relationship between the monitors attached to monitor interface 150-1 through 150-M.

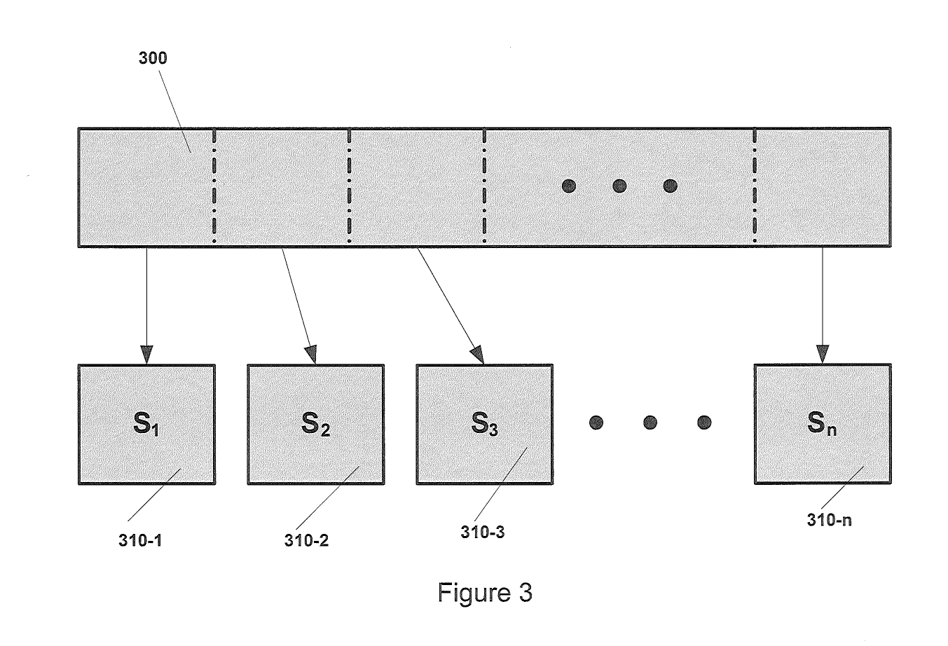

FIG. 3 illustrates splitting of video image 300 horizontally into n images 310-1 through 310-n. In some instances, each of images 310-1 through 310-n is the same size so that each of them is horizontally 1/n the size of video image 300. Vertically, each of images 310-1 through 310-n is the same size as that of video image 300. However, each of images 310-1 through 310-n may be of differing sizes, in which case the sum of the horizontal sizes of each of images 310-1 through 310-n is the same as that of video image 300.

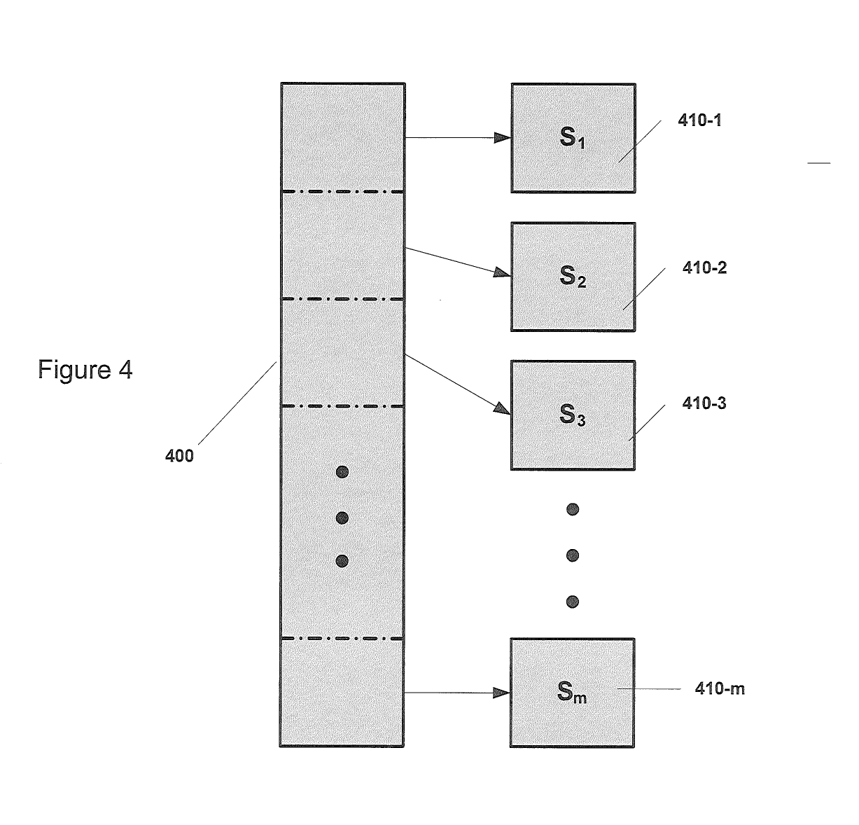

FIG. 4 illustrates splitting of video image 400 vertically into m images 410-1 through 410-m. In some instances, each of images 410-1 through 410-m is the same size so that each of them is vertically 1/m the size of video image 400. Horizontally, each of images 410-1 through 410-m is the same size as that of video image 400. However, each of images 410-1 through 410-m may be of differing sizes, in which case the sum of the vertical sizes of each of images 410-1 through 410-m is the same as that of video image 400.

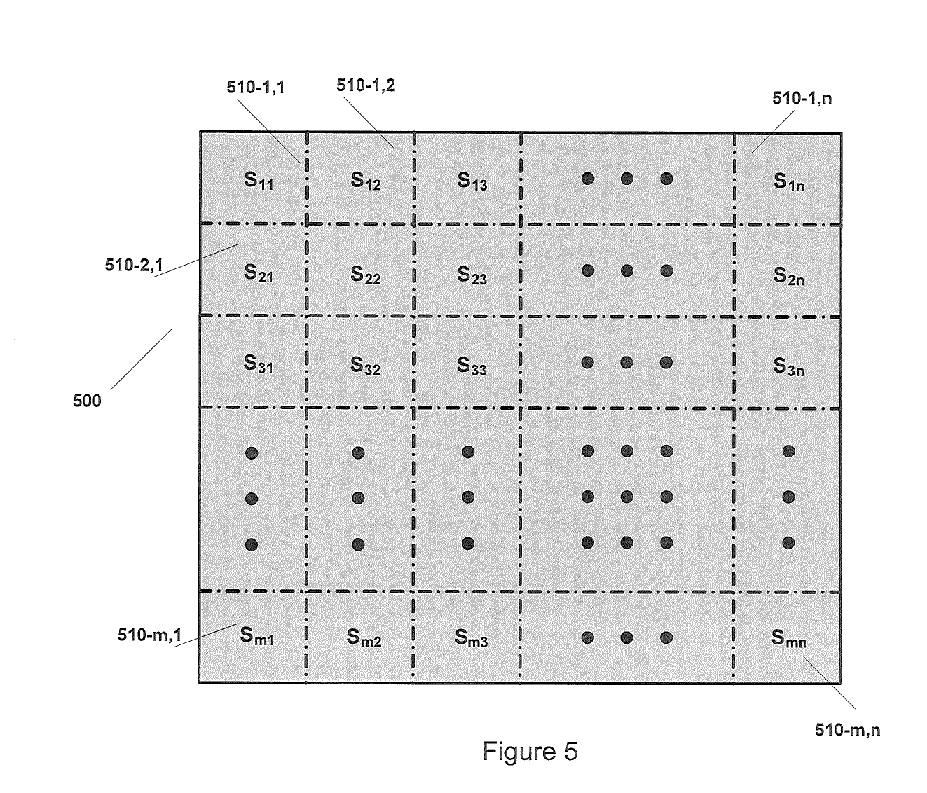

FIG. 5 illustrates splitting of video image 500 both vertically and horizontally into video images. As shown, a larger image 500 is split into m*n smaller images 510-1,1 through 510-m,n. In some embodiments, the image is split into n smaller images horizontally and m images vertically. In some embodiments, the some of the images sizes span the larger image 500. In the case where each of the smaller images 510-1,1 through 510-m,n are the same size, then the size of each of the smaller images is 1/n horizontally and 1/m vertically times the size of larger image 500.

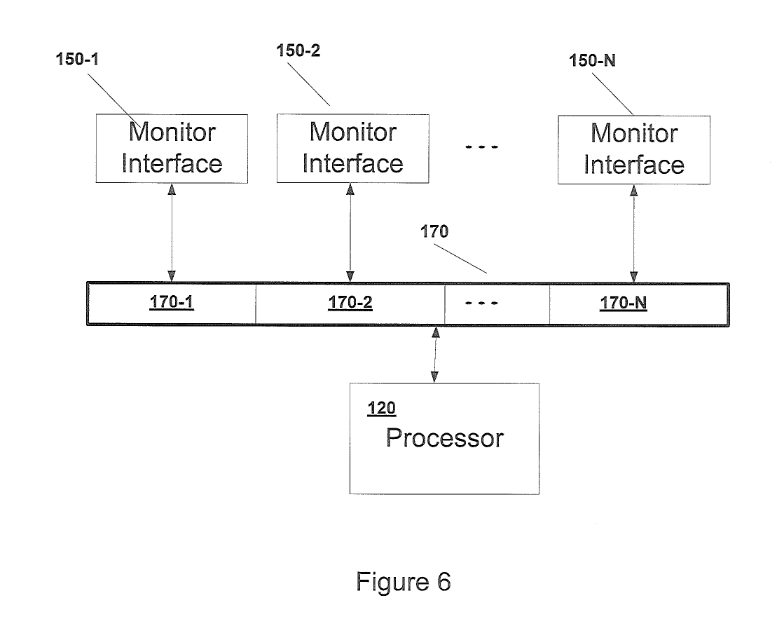

FIG. 6 illustrates an embodiment of the present invention that utilizes a line buffer 170 in splitting the incoming video image. As illustrated in FIG. 6, processor 120 loads buffer 170 with a line of video data from the video image received from source 102. Buffer 170 can be partitioned into N sections 170-1 through 170-N. Each of the N sections is read, respectively, by one of monitors drivers 150-1 through 150-N. In some embodiments, processor 120 writes a line of video data into line buffer 170 sequentially. Each of monitor drivers 150-1 through 150-N, then, starts reading data from the corresponding one of sections 170-1 through 170-N when new data is written into that section of buffer 170. In this fashion, the pixel rates utilized in each of monitor drivers 150-1 through 150-N can be significantly lower than the pixel rates utilized by source 102.

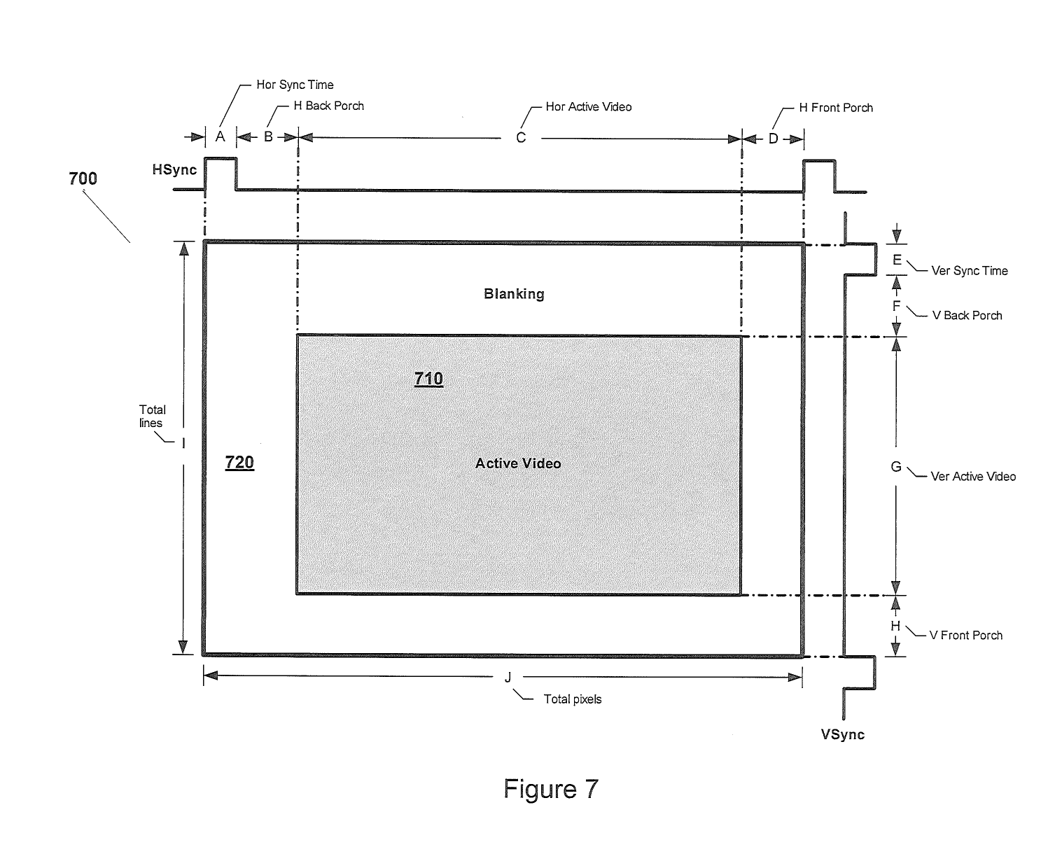

FIG. 7 illustrates the video timing for a large video image 700. Video image 700 includes an active area 710 and a blanking region 720 surrounding active region 710. Blanking region 720 is defined by the horizontal blanking period and the vertical blanking period. Video timing is controlled by a horizontal sync signal and a vertical sync signal. In the horizontal direction, timing starts at the rising edge of the horizontal sync signal. The width of the timing signal is the horizontal sync time A. The back porch time B indicates the blanking time between the falling edge of the horizontal sync signal, at the end of the horizontal sync time A, to the beginning of the active area 710 in the horizontal direction. The time for active area 710 is given by the horizontal active video time C. The time from the end of the horizontal active area C to the rising edge of the next horizontal sync signal is the front porch time D.

Similarly in the vertical direction, timing starts at the rising edge of the vertical sync signal. The width of the vertical sync signal is designated the vertical sync time E. The time between the falling edge of the vertical sync signal and the beginning of active area 710 is designated the vertical back porch time F. The vertical active area is designated in the vertical active video time G. Further, the time between the end of the vertical active area and the rising edge of the next vertical sync signal is designated the vertical front porch H.

The timing is designated for each of the video images is designated for each monitor. Further, the timing shown in FIG. 7 determines the pixel timing for video image 700. The timing designations A, B, C, D may be in pixels. In that case, the total number of pixels J in image 700 can be given by J=A+B+C+D. Similarly, the timing designations E, F, G, and H may be in lines so that the total number of lines L in image 700 can be given by L=E+F+G+H.

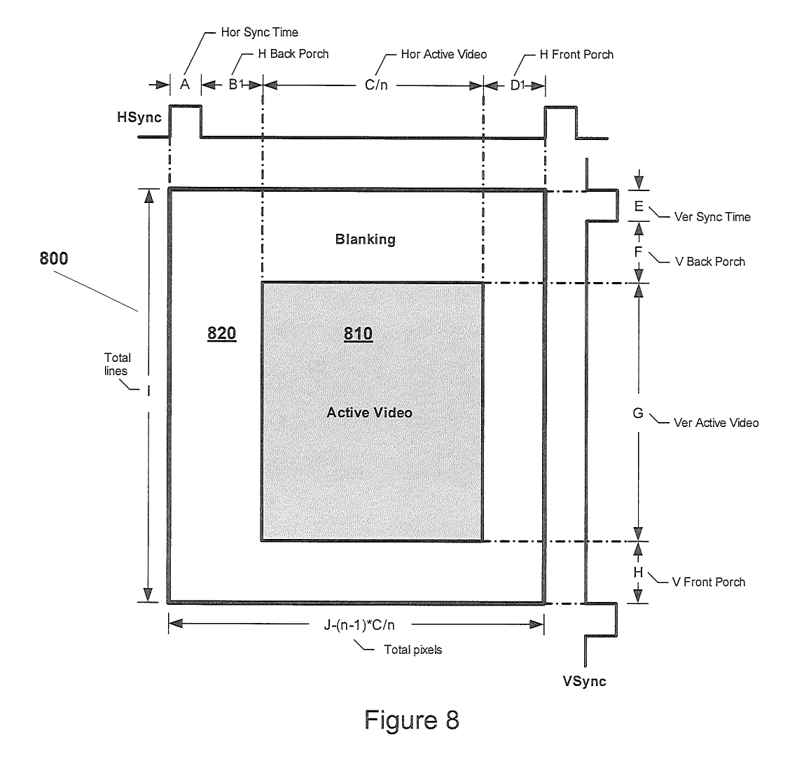

FIG. 8 illustrates the video timing for an image 800 that is split from image 700 horizontally as shown in FIG. 3. As shown in FIG. 8, image 800 includes an active area 810 and a blanking area 820. Video image 800, then, is one of video images 310-1 through 310-n. Again, the video image 800 includes an active area 810 and a blanking area 820. As shown in FIG. 8, the vertical sync and horizontal sync signals are the same as the vertical sync and horizontal sync signals illustrated in FIG. 7 for video image 700.

As shown in FIG. 8, the vertical timing is the same as than shown for video image 700 in FIG. 7. However, the active area timing in FIG. 8 is the size of the active area for the split off image 800. In an example where the image 700 is split horizontally into multiple equal images, of which image 800 is one, then the timing for the active area is given by C/n. However, the overall timing for image 800 is the same as that for image 700 in FIG. 7. Therefore, J=A+B+C+D=A+B1+C/n+D1. The back porch B1 and the front porch D1 of image 800 are both adjusted from the back porch B and front porch D of the larger image 700 shown in FIG. 7. Further, back porch B1 and front porch D1 can be set to correspond with the receipt of data in the corresponding buffer area 170-j corresponding to image 800.

In some embodiments, the pixel rate for display of image 800 can be smaller, so that the number of pixels in the back porch and front porch areas, B and D, respectively, are the same as that shown for image 700 in FIG. 7. In other words, B1=B and D1=D. In that case, the total number of pixels in image 800 is given by J−(n−1)C/n=A+B+C/n+D. In that case, the pixel timing for image 800 is arranged so that the overall timing of image 800 matches that of image 700.

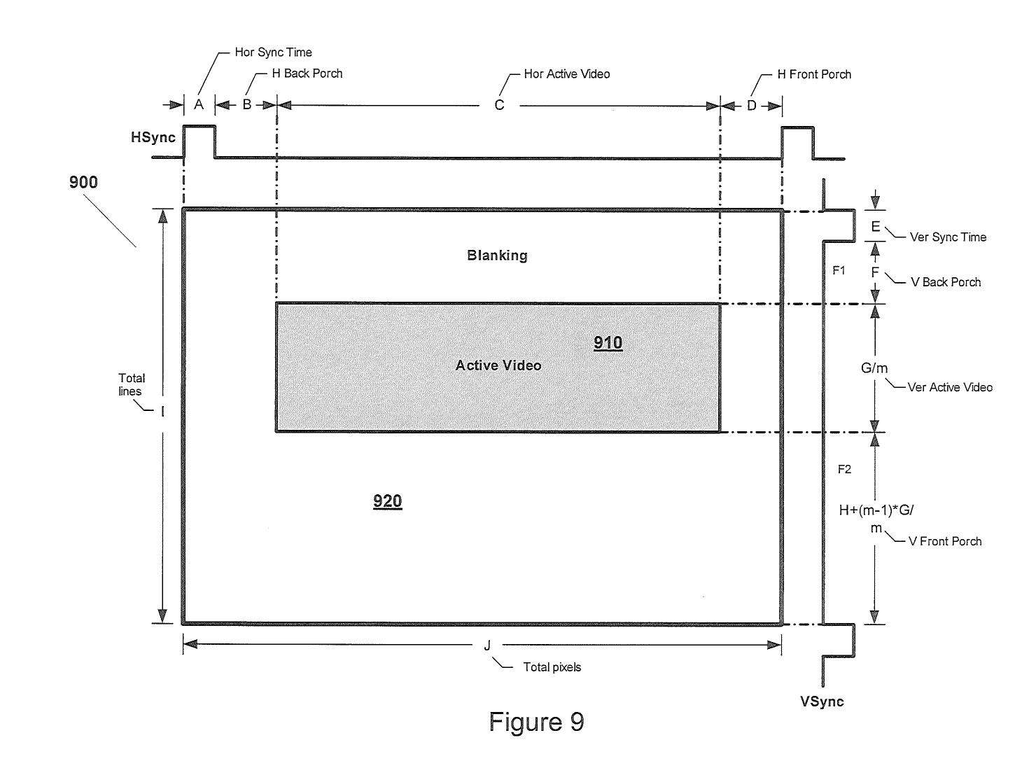

FIG. 9 illustrates the timing for an image 900 that is split from image 700 vertically and therefore can be one of images 410-1 through 410-m shown in FIG. 4. As shown in FIG. 9, image 900 includes active area 910 and blanking area 920. As shown in FIG. 9, the horizontal timing remains the same as that shown in FIG. 7. The vertical timing is adjusted so that the number of lines in the vertical active timing area is adjusted to match the number of lines in image 900. In cases where each of images 410-1 through 410-m are the same, the vertical active timing area becomes G/m. The back porch F1 and front porch H1 can be adjusted so that the total number of lines is the same as that in FIG. 7, L=E+F+G+H=E+F1+G/m+H1.

Further, the timing can be adjusted to correspond with the timing of when data is available for image 900. For example, if image 900 corresponds to image 410-1, then F1=F and H1=H+(m−1)G/m.

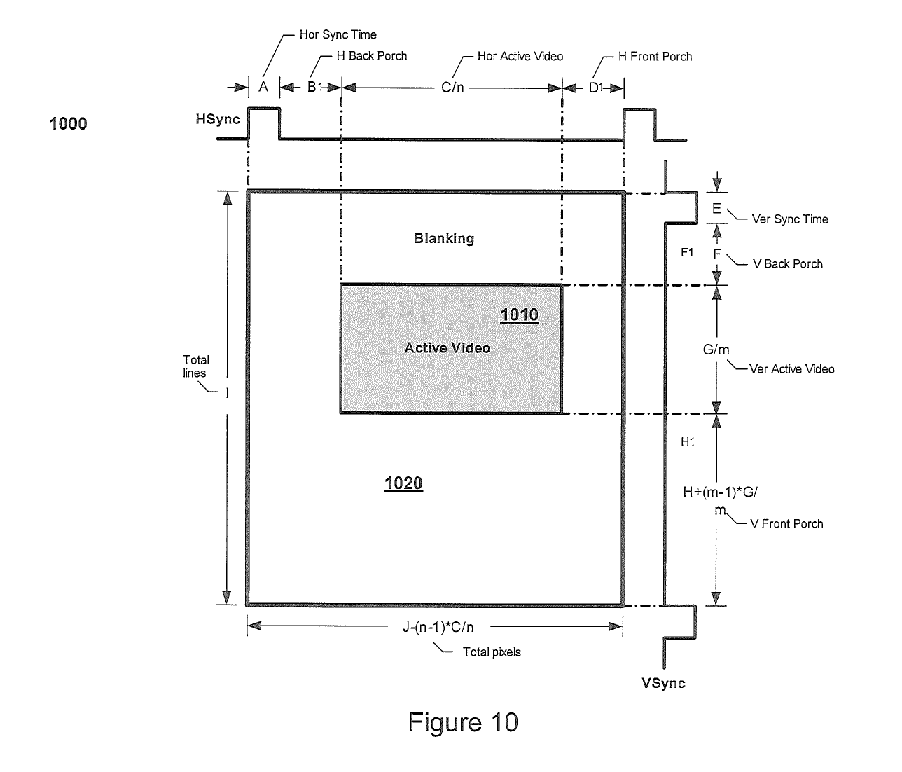

FIG. 10 illustrates an image 1000 that is split from image 700 both horizontally and vertically. As such, image 1000 can be one of images 510-1,1 through 510-m,n as shown in FIG. 5. Both the horizontal and the vertical timing are adjusted as described above with FIG. 8 and FIG. 9, respectively. In other words, the horizontal timing is such that the active area timing is given by C/n and back porch B1 and front porch D1 can be modified, or in the case where the pixel timing is also adjusted can be the same as back porch B and front porch D. The vertical timing can be adjusted so that vertical active timing is G/m while back porch F1 and front porch H1 is adjusted. In the case where image 1000 includes the first line, F1 can be F and H1 set to H+(m−1)G/m.

The examples provided above are exemplary only and are not intended to be limiting. One skilled in the art may readily devise other multi-monitor systems consistent with embodiments of the present invention which are intended to be within the scope of this disclosure. As such, the application is limited only by the following claims.

We claim:

1. A multi-monitor driver, comprising:
a processor coupled to receive an image;
a line buffer coupled to the processor, the processor writing pixel data from the image into the line buffer; and
a plurality of monitor interfaces, each coupled to receive data from a corresponding portion of the line buffer to form a smaller image that is a portion of the image.

2. The driver of claim 1, wherein each of the plurality of monitor interfaces provides a video timing related to a video timing of the image, wherein the video timing of the image includes a horizontal timing, a horizontal back porch timing, a horizontal active area timing, a horizontal front porch timing, a vertical timing, a vertical back porch timing, a vertical active area timing, and a vertical front porch timing.

3. The driver of claim 2, wherein the smaller image of each of the plurality of monitor interfaces corresponds to a horizontal split of the image and the video timing is the same as the video timing of the image except that the horizontal active area timing is adjusted to match an active area of the smaller image and the horizontal back porch timing and the horizontal front porch timing is adjusted accordingly.

4. The driver of claim 3, wherein the horizontal back porch timing and the horizontal front porch timing remains the same and a pixel rate is adjusted.

5. The driver of claim 2, wherein the smaller image of each of the plurality of monitor interfaces corresponds to a vertical split of the image and the video timing is the same as the video timing of the image except that the vertical active area timing is adjusted to match an active area of the smaller image and the vertical back porch and the vertical front porch are adjusted.

6. A method of splitting an image, comprising:
receiving the image;
writing data from the image into a line buffer;
reading video data from a portion of the line buffer to form a smaller image that corresponds to a portion of the image.

7. The method of claim 6, further including providing a video timing for the small image that is related to a video timing of the image, wherein the video timing of the image includes a horizontal timing, a horizontal back porch timing, a horizontal active area timing, a horizontal front porch timing, a vertical timing, a vertical back porch timing, a vertical active area timing, and a vertical front porch timing.

8. The driver of claim 7, wherein the smaller image of each of the plurality of monitor interfaces corresponds to a horizontal split of the image and the video timing is the same as the video timing of the image except that the horizontal active area timing is adjusted to match an active area of the smaller image and the horizontal back porch timing and the horizontal front porch timing is adjusted accordingly.

9. The driver of claim 8 wherein the horizontal back porch timing and the horizontal front porch timing remains the same and a pixel rate is adjusted.

10. The driver of claim 7, wherein the smaller image of each of the plurality of monitor interfaces corresponds to a vertical split of the image and the video timing is the same as the video timing of the image except that the vertical active area timing is adjusted to match an active area of the smaller image and the vertical back porch and the vertical front porch are adjusted.
